(19) United States
(12) Patent Application Publication
(10) Pub. No.: US 2007/0235243 A1
(43) Pub. Date: Oct. 11, 2007

(54) Seatbelt minder

(76) Inventors: John F. Nathan, White Lake, MI (US); Karl Kennedy, Fraser, MI (US); Rob Wegrzyn, Canton, MI (US); Oliver J. Young, Grosse Pointe, MI (US); Christopher Ricard, Rochester, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/400,477

(22) Filed: Apr. 7, 2006

(51) Int. Cl. B60R 21/015; A47C 31/00; B60K 28/00

(52) U.S. Cl. 180/273; 73/862.391; 297/217.2; 340/667; 177/144; 280/735

(57) ABSTRACT

A vehicle seat sensing system is provided for detecting a presence of an unrestrained vehicle occupant on a vehicle seat cushion. A plurality of sensor assemblies are in spaced relation to one another and disposed adjacent a lower surface of said vehicle seat cushion. Each of the plurality of sensor assemblies variably sense a displacement of the vehicle seat cushion. A summing circuit disposed in proximity to the plurality of sensor assemblies is provided for summing sensed signals from the plurality of sensor assemblies. The summing circuit provides a summed output signal indicative of a presence of a vehicle occupant. The summed output signal is output exterior of the vehicle seat for determining whether the vehicle occupant is seated on the vehicle seat cushion.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not Applicable

### BACKGROUND OF THE INVENTION

1. Field of the Invention

This invention relates in general to vehicle safety devices and in particular to a system for alerting a vehicle occupant of an unsecured safety restraint device.

2. Description of the Related Art

Automotive vehicles employ safety restraint devices accommodate the passengers of the vehicle. The safety restraint systems restrain a vehicle occupant in a vehicle seat for protecting the occupant in the event of a collision. The primary restraint system commonly employed in most vehicles today is the seatbelt. Seatbelts usually include a lap belt and a shoulder belt that extends diagonally across the occupant's torso from one end of the lap belt to a mounting structure located proximate to the occupant's opposite shoulder.

Safety restraint indicators are provided to alert a driver that its seat belt is unlatched. Conditions for enabling the seat belt indicator include the ignition being in the run position and the seat belt latch of the driver being in an unlatched position. Typically, the unlatched seat belt is monitored only for the driver because typical systems are unaware of whether other vehicle occupants are seated in the vehicle and in which seat are they seated.

Accordingly, there remains an ongoing need in the art for a safety restraint alert system that is responsive to all vehicle occupants seated within the vehicle that do not have their respective seat belt latched to be alerted.

### BRIEF SUMMARY OF THE INVENTION

The present invention has the advantage of detecting the presence of one or more unrestrained vehicle occupants seated within the vehicle and alert them accordingly of the unlatched safety restraint device. The present invention further provides an array of sensors which sums the signal outputs of all the sensors and outputs a summed signal to a controller indicative of the presence of the vehicle occupant in a respective seat for determination of whether the safety restraint indicator should be enabled.

In one aspect of the present invention, a vehicle seat sensing system is provided for detecting a presence of an unrestrained vehicle occupant on a vehicle seat cushion. A plurality of sensor assemblies are in spaced relation to one another and disposed adjacent a lower surface of said vehicle seat cushion. Each of the plurality of sensor assemblies variably sense a displacement of the vehicle seat cushion. A summing circuit disposed in proximity to the plurality of sensor assemblies is provided for summing sensed signals from the plurality of sensor assemblies. The summing circuit provides a summed output signal indicative of a presence of a vehicle occupant. The summed output signal is output exterior of the vehicle seat for determining whether the vehicle occupant is seated on the vehicle seat cushion.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is an exploded perspective view of a vehicle seat cushion and mat sensor array assembly in accordance with a first embodiment of the present invention.

FIG. 2 is a cross section view of a portion of a sensor of the mat sensor array assembly in accordance with the first embodiment of the present invention.

FIG. 3 is a partial cross section view of a portion of a sensor of the mat sensor array assembly in accordance with the first embodiment of the present invention.

FIG. 4 is a block diagram of a safety restraint alert system in accordance with the first embodiment of the present invention.

FIG. 5 is an individual sensor voltage output curve in accordance with the first embodiment of the present invention.

FIG. 6 is a summed sensor voltage output curve in accordance with the first embodiment of the present invention.

FIG. 7 is a resistance output curve in accordance with a second embodiment of the present invention.

### DETAILED DESCRIPTION OF THE PREFERRED EMBODIMENT

Referring now to the drawings, there is illustrated in FIG. 1 a seat cushion assembly indicated generally at 10. The assembly 10 includes a seat cushion 12 and a sensor mat array assembly 14 mounted in the seat cushion 12. The seat cushion 12 can have any desired contoured shape and is adapted to be mounted on a vehicle seat frame (not shown). As will be explained in detail below, the sensor mat array assembly 14 includes a plurality of sensor assemblies 16, namely 16a, 16b, 16c, 16d, 16e which detect the presence of an occupant seated on the seat. The sensor mat array assembly 14 may include more or less sensors from that which is shown in FIG. 1 to sense for the vehicle occupant. The plurality of sensor assemblies 16 include movably mounted members which detect displacement therebetween caused by the weight of an occupant seated on the seat cushion 12.

The seat cushion 12 has an upper seating surface 18 and a lower or downwardly facing surface 20. The seat cushion 12 can be formed of any suitable layers of material, such as a foam layer and an outer trim material, which permit the transfer of the force from an object resting on the cushion to be transferred to the plurality of sensor assemblies 16. Preferably, the mat sensor array assembly 14 is disposed adjacent the lower surface 20 of the vehicle seat cushion 12. The plurality of sensor assemblies 16 may be positioned at any suitable position adjacent the seat cushion 12 which enables forces from the weight of an occupant on the cushion assembly 10 acting on the upper seating surface 18 to be transferred through the seat cushion 12 and onto the plurality of sensor assemblies 16.

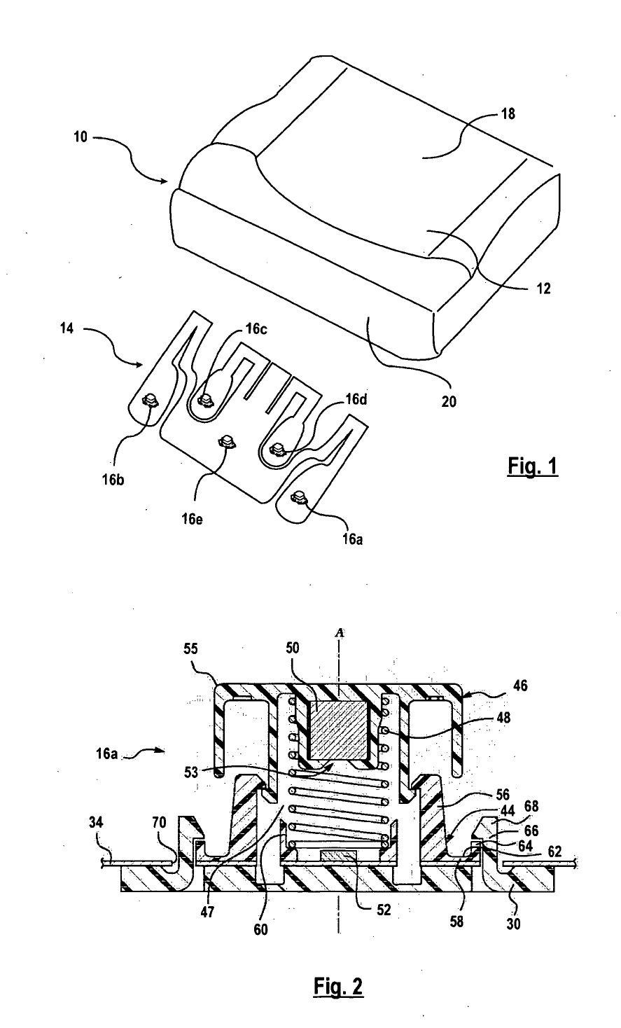

Preferably, sensor mat array assembly 14 includes a flexible printed circuit board. The sensor mat array assembly 14 defines a plurality of mounting locations for mounting each of the plurality of sensor assemblies 16. It should be understood that the plurality of sensor assemblies 16 can be mounted on the sensor mat array assembly 14 by any suitable manner. Alternatively, the sensor mat array assembly 14 may be formed on a rigid material, such as plastic, to provide a generally rigid structure for mounting and positioning the plurality of sensor assemblies 16 relative to one another. Each mounting location includes a retainer 58 (shown in FIG. 2) for receiving a respective sensing device. In the embodiment in FIG. 1, there are preferably five mounting locations. Those having ordinary skill in the art will appreciate that although FIG. 1 shows five respective sensor assemblies, the mat sensor array assembly 14 of the present invention could employ any number of sensor assemblies, including more or less than what is shown in FIG. 1. In addition, the plurality of sensor assemblies 16 may be positioned at various locations on the mat sensor array assembly 14 to sense one or more region. The mat array sensor assembly 14 may also include different mat sensor array configurations.

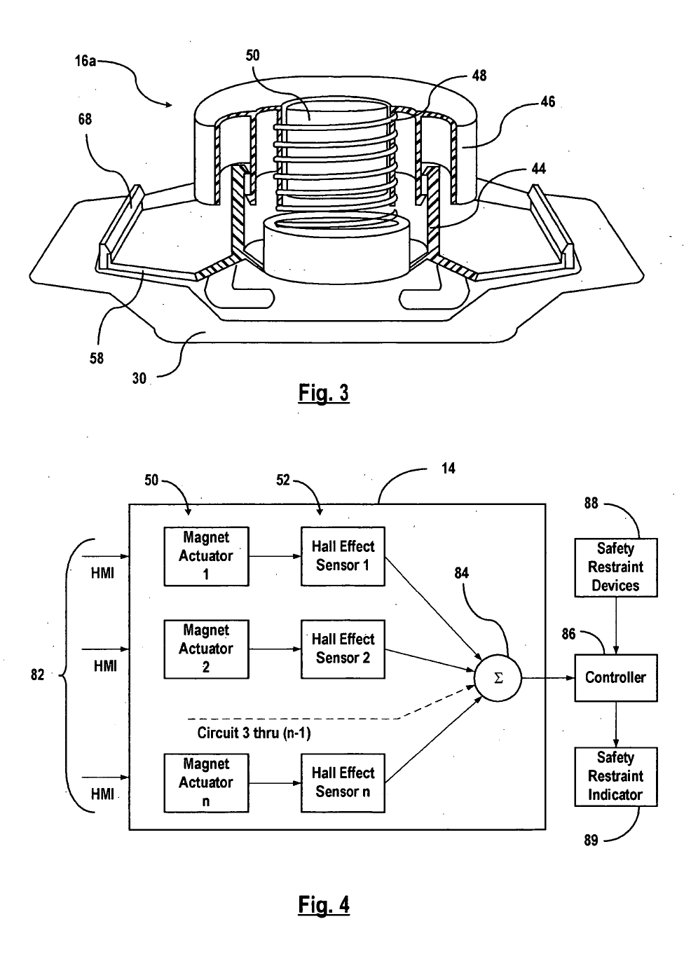

FIGS. 2 and 3 illustrate a cross section view and a perspective view (with a partial cross section), respectively, of the respective sensor assembly 16a of the mat sensor array assembly 14 shown in FIG. 1. The sensor shown is the type described in detail in applicant's co-pending U.S. patent application Ser. No. 11/085,916 filed Mar. 22, 2005, which is incorporated by reference herein in its entirety. Alternatively, other sensor assemblies may be utilized including those disclosed in applicant's co-pending U.S. patent application Ser. No. 10/974,101 filed Oct. 27, 2004, U.S. patent application Ser. No. 10/606,649 filed Jun. 26, 2003, and U.S. patent application Ser. No. 10/748,536 filed Dec. 30, 2003 which are all incorporated by reference in their entirety herein.

The mat sensor array assembly 14 includes a circuit carrier circuit carrier tray 30 and a circuit carrier 34. The circuit carrier circuit carrier tray 30 is similar to the tray described in detail in applicant's co-pending U.S. Pat. No. 6,975,239 issued Dec. 30, 2005, which is incorporated by reference in its entirety herein.

The sensor assembly 16a includes a base, generally indicated at 44, and an upper slide member, generally indicated at 46. The upper slide member 46 is slidingly supported for movement toward and away from the base 44 as will be discussed in greater detail below. The sensor assembly 16a defines an interior cavity 47. The sensor assembly 16a also includes a biasing member 48 that biases the upper slide member 46 away from the base 44. The sensor assembly 16a includes an emitter 50 and a sensing device 52, such as a hall effect sensor. The sensing device 52 is disposed in spaced relationship to the corresponding emitter 50, and the sensing device 52 is operable to detect relative distance to the emitter 50. Each sensor assembly 16 of the mat array assembly, as shown in FIG. 1, includes an associated emitter 50 and sensing device 52.

The emitter 50 and the sensing device 52 is supported by the upper slide member 46 so as to be supported for movement toward and away from the other of the emitter 50 and the sensing device 52. For instance, in the embodiment shown, the upper slide member 46 includes a retainer, generally indicated at 53, and the emitter 50 is supported by the retainer 53. The sensing device 52 is supported by the circuit carrier 34 and is disposed within the interior cavity 47 of the sensor assembly 16a. As such, when the upper slide member 46 moves toward and away from the base 44, the emitter 50 moves with the upper slide member 46 toward and away from the sensing device 52 for detecting the condition of the vehicle seat cushion 12. The retainer 53 is open to the interior cavity 47 of the sensor assembly 16a. The upper slide member 46 includes an exterior surface 55 that is continuous to thereby block contaminants from entering the sensor assembly 16a.

A retainer 58 includes a plurality of retaining ridges 64. The ridges 64 curve inward from the outer periphery of the retainer 58 and extend away from a topside 62 of the retainer 58 toward the seat cushion 12. In the embodiment shown, the ridges 64 are disposed on opposite sides of the retainer 58. The circuit carrier circuit carrier tray 30 includes a plurality of clips 66 for mounting the base 44 to the circuit carrier circuit carrier tray 30. The clips 66 each extend from the upper surface of the circuit carrier tray 30, through apertures 70 in the circuit carrier 34, and toward the base 44. The clips 66 each include an enlarged head 68. To mount the base 44 to the circuit carrier tray 30, the base 44 is positioned between the heads 68 and is moved axially toward the upper surface of the circuit carrier tray 30. As the heads 68 contact the retaining ridges 64, the clips 66 bend outwardly. When the retaining ridges 64 move past the heads 68, the clips 66 resiliently bend back toward the retaining ridges 64 and the heads 68 move over the retaining ridges 64, thereby mounting the base 44 to the circuit carrier tray 30.

As a force from an occupant of the vehicle sitting on the seat cushion 12 is exerted on the plurality of sensor assemblies 16, the emitter 50 is displaced in a vertically downward direction toward the sensing device 52. The sensing device 52 measures the magnetic field generated by the displaced position of the emitter 50 relative to the sensing device 52. The sensor assembly 16a thereby generates a sensed output signal corresponding to the weight/force acting on the upper slide member 46 of the respective sensor assembly 16a.

Referring to FIG. 4, human machine interface (HMI) input signals 82 are transmitted to the plurality of sensor assemblies 16 resulting from a vehicle occupant sitting on a vehicle seat cushion 12. As a downward force is applied to the upper slide member 46 of each respective sensor, the emitter 50 of each respective sensor is displaced downward in the direction of the respective sensing devices 40. A respective magnetic field is generated by each respective displaced emitter 50. Each respective sensing device 52 measures the magnetic field generated by its associated emitter 50.

The actual measured magnetic field values of each respective sensor are provided to a summing circuit 84 which sums each actual sensed output of each respective sensor for determining a summed output signal. The summing circuit 84 is part of a microchip integrated into the mat sensor array assembly 14.

The summed output signal is then provided to a controller 86 disposed exterior to the vehicle seat cushion 12 for processing. Preferably, a 5 and/or 12 volt power input and ground are provided to the mat sensor array assembly 14 through a connector by the controller or other power source device. The required voltage power input and ground for operating the sensing devices is dependent upon the number of sensor assemblies utilized in the mat sensor array assembly 14. Preferably, to reduce part complexity and cost reduction, the controller 50 may be a control unit that provides other control functionality to other vehicle functions such as a control unit for deploying safety devices such are air bags or other vehicle related functions. The controller 50 receives the summed output signal and compares the summed output signal to a predetermined threshold to determine whether a vehicle occupant is seated on the vehicle seat cushion 12.

A safety restraint input signal is provided to the controller 50 by a safety restraint device 88 for indicating whether the safety restraint device 88, such as a seat belt, associated with the respective monitored vehicle seat cushion 12 is secured. If the summed output signal indicates the vehicle occupant is seated on the vehicle seat cushion 12 and the safety restraint input signal indicates that the safety restraint device 88 is unsecured, a safety restraint indicator 89 is enabled by the controller 50 for alerting the vehicle occupant of the unsecured safety restraint device 88. The safety restraint alert system may be utilized for each seat within the vehicle.

Summing each of the plurality of sensor assemblies 16 within the mat sensor array assembly 14 reduces the number of circuits that must be connected to controller 50. This is advantageous when utilizing an existing controller such as that of the air bag module, which has a limited number of I/O capability. Additionally, providing only a single summed output to the controller 50 eliminates any requirement for sensor differentiation or complex sensor differentiation methods. The summation provides an enhanced and more distinguishable output data signal than an individual output signal of a single sensor.

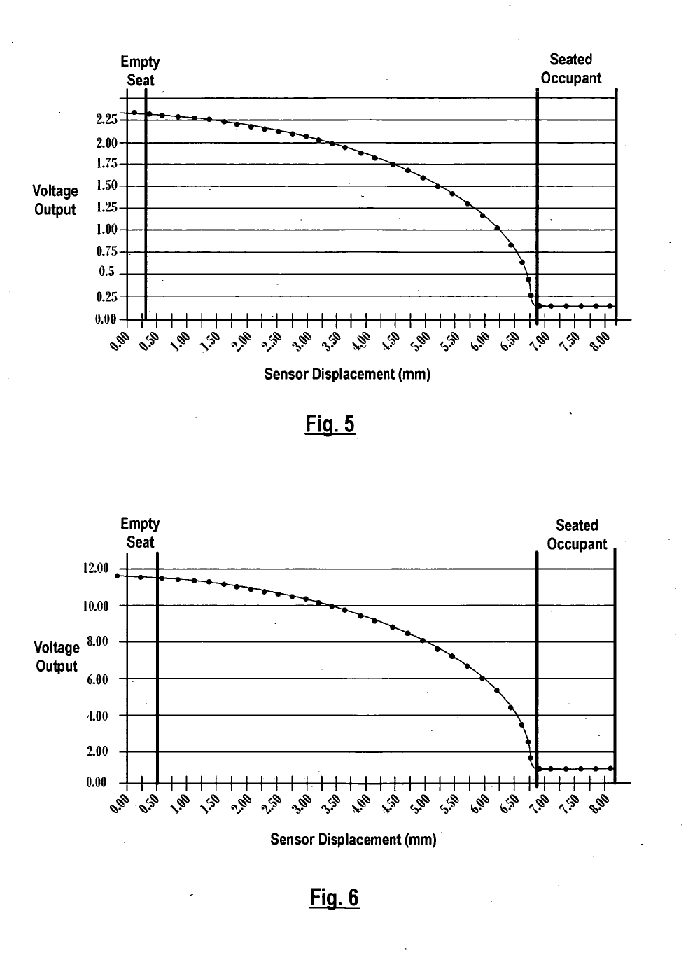

FIG. 5 illustrates an example of a respective voltage output curve for an individual respective sensor. Utilizing a respective sensor to determined a vehicle occupant, an empty seat condition is identified on the voltage output curve for a single sensor where the output voltage measurement is substantially in a range of 2.30-2.26 volts and the sensor displacement (i.e., magnet displacement towards sensing device) is substantially in a range (e.g., 0-0.5 mm).

A seated occupant is identified for a respective sensor when the output voltage measurement is substantially in a range of 0.17-0.21 volts and the sensor displacement (i.e., magnet displacement towards sensing device) is substantially in a range of 6.80-8.25 mm. The voltage output ranges and sensor displacement ranges as shown and described above are not definitive ranges but are exemplary to show relative comparison between an individual sensor providing a single sensor output and summed output for a plurality of sensor assemblies.

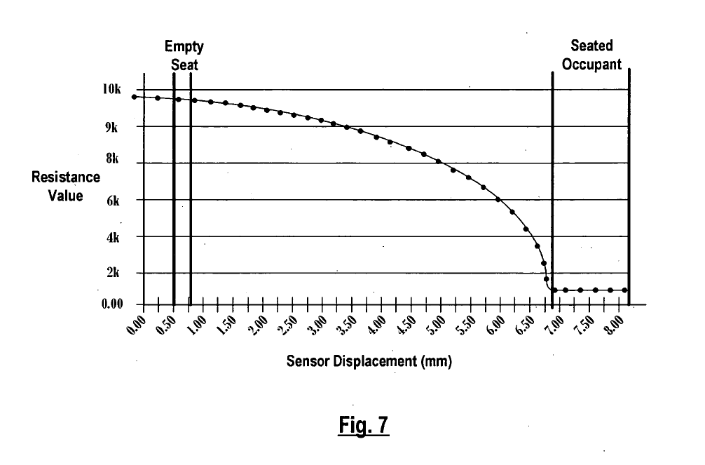

FIG. 6 illustrates an example of a respective voltage output curve for the summation of the plurality of sensor assemblies. The empty seat condition is identified for a summation of the sensors where the output voltage measurement is substantially in the voltage output range of 11.36-11.46 volts and the sensor displacement (i.e., magnet displacement towards sensing device) is substantially in the range of 0-0.5 mm.

A seated occupant is identified for the summation of the sensors when the summed output voltage is substantially in a voltage output range of 0.17-0.21 volts and the each sensor displacement (i.e., magnet displacement towards sensing device) is substantially in a range of 6.80-8.25 mm. As described above, the above voltage output ranges and sensor displacement ranges are not definitive and are exemplary for relative comparison with an individual sensor output. In comparison to FIG. 5, the summation of the measured output voltages provides a greater discrepancy range between a seated occupant and an empty seat condition as opposed to the discrepancy range between the seated occupant and empty seat occupant for a single sensor which allows for increased reliability of detecting a person seated on the vehicle seat cushion.

FIG. 7 illustrates an example of a respective resistance output curve converted from the summed voltage output of the plurality of sensor assemblies. A resistance output signal may be utilized when the controlling device receiving the output signal requires a resistance value as opposed to a summed voltage signal. Preferably, a voltage-to-resistance converter such as utilizing pair of digital potentiometers may be used to convert the summed voltage output signal to a resistance value. The empty seat condition is identified for an output signal where the converted resistance value is substantially in a first resistance output range and the sensor displacement (i.e., magnet displacement towards sensing device) is substantially in the a first displacement range.

The seated occupant is identified when the converted resistance value is substantially in a second resistance output range and the each sensor displacement (i.e., magnet displacement towards sensing device) is in a second displacement range.

It should be noted that the output voltages illustrated in FIG. 5-6 and the converted resistance value illustrated in FIG. 7 in addition to the sensor displacement ranges are exemplary and that the actual output signals and their respective ranges may change to accommodate varying vehicle seats having trim material and foam cushion of different softness/hardness, in addition to occupant weight criteria.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

What is claimed is:

1. A vehicle seat sensing system for detecting a presence of an unrestrained vehicle occupant on a vehicle seat cushion comprising:
a plurality of sensor assemblies in spaced relation to one another and disposed adjacent a lower surface of said vehicle seat cushion, wherein each of said plurality of sensor assemblies variably sense a displacement of said vehicle seat cushion; and
a summing circuit disposed in proximity to said plurality of sensor assemblies for summing sensed signals from said plurality of sensor assemblies, said summing circuit providing a summed output signal indicative of a presence of a vehicle occupant; and
wherein said summed output signal is output exterior of said vehicle seat for determining whether said vehicle occupant is seated on said vehicle seat cushion.

2. The vehicle seat sensing system of claim 1 wherein said plurality of sensor assemblies are arranged in a mat sensor array assembly.

3. The vehicle seat sensing system of claim 2 wherein said summing circuit is disposed on said mat sensor array assembly.

4. The vehicle seat sensing system of claim 3 wherein said mat sensor array assembly is a flex circuit.

5. The vehicle seat sensing system of claim 1 wherein said plurality of sensor assemblies comprise hall effect sensors.

6. The vehicle seat sensing system of claim 1 wherein said plurality of sensor assemblies comprise proportional sensors.

7. The safety restraint alert system of claim 1 wherein said summed output signal is adapted to be processed by a occupant sensing system.

8. The vehicle seat sensing system of claim 1 wherein said summed output signal is adapted to be output to an occupant sensing system for detecting an unrestrained vehicle occupant seated on said vehicle seat cushion.

9. The vehicle seat sensing system of claim 1 wherein said summed output signal is adapted to be used for detecting an unrestrained vehicle occupant seated on said vehicle seat cushion.

10. The vehicle seat sensing system of claim 1 wherein said plurality of sensor assemblies sense a respective region of said vehicle seat cushion.

11. The vehicle seat sensing system of claim 1 wherein said plurality of sensor assemblies sense respective regions of said vehicle seat cushion.

12. The vehicle seat sensing system of claim 1 wherein said summed output signal is a summed voltage signal.

13. The vehicle seat sensing system of claim 1 wherein said summed output signal is a resistance signal.

14. A method for detecting an unrestrained vehicle occupant seated on a vehicle seat cushion of a vehicle, said method comprising the steps of:
providing a plurality of sensor assemblies in spaced relation to one another disposed adjacent a lower surface of said vehicle seat cushion, each of said plurality of sensor assemblies output a sensed signal for variably sensing a displacement of a respective region of said vehicle seat cushion;
summing each sensed output signal from said plurality of sensor assemblies;
outputting a summed output signal exterior to said vehicle seat to be used for determining said presence of said vehicle occupant.

15. The method of claim 14 wherein outputting said summed output signal is adapted to be used for detecting an unrestrained vehicle occupant.

16. The method of claim 14 wherein said sensors comprise hall effect sensors.

17. The method of claim 14 wherein said step of determining whether said vehicle occupant is unrestrained includes determining if a seat belt harness is unsecured.

18. The method of claim 14 wherein determining whether a vehicle occupant is seated on said vehicle seat cushion in response to said summed output signal includes determining whether said summed output signal is greater than a predetermined threshold.

19. The method of claim 14 wherein said plurality of sensor assemblies each sense a proportional displacement of said vehicle seat cushion.

20. The method of claim 14 wherein said summed output signal is converted to a resistance value.
